(19) United States
(12) Patent Application Publication
(10) Pub. No.: US 2002/0030007 A1
(43) Pub. Date: Mar. 14, 2002

(54) Oil filter and method of manufacturing such filters

(76) Inventor: Saeng Gon Koh, Yongin-shi (KR)

Correspondence Address: STAAS & HALSEY LLP, 700 11TH STREET, NW, SUITE 500, WASHINGTON, DC, 20001, US

(21) Appl. No.: 09/793,543

(22) Filed: Feb. 27, 2001

(30) Foreign Application Priority Data
Sep. 7, 2000 (KR) 2000-52934

(51) Int. Cl. B01D 27/08

(52) U.S. Cl. 210/443

(57) ABSTRACT

The present invention provides an oil filter for internal combustion engines and a method of manufacturing such filters. The oil filter is effectively and completely sealed by an easy and simple assemblage of a bottom plate with a filter housing, thus being free from a conventional seaming cap and being effectively produced using a reduced amount of material through a simplified production process requiring fewer man hours, and thereby being reduced in its production cost. This oil filter also simplifies the construction of the filter production system, and is improved in productivity. The oil filter and the method of this invention effectively protect workers from safety hazards during the process of producing the filters. In this oil filter, an unexpected leakage of oil from a filtering element through the upper and lower adhesive parts is almost completely prevented, and so the filtering element performs its desired filtering function of feeding desirably filtered oil to an engine for an expected lengthy period of time. The engine is thus protected from any impurities of the oil. This oil filter also enlarges the effective filtering area of the filtering element, thus accomplishing a desired filtering effect using a small-size filtering paper.

### BACKGROUND OF THE INVENTION

1. Field of the Invention

The present invention relates to an oil filter used for filtering engine oil and feeding the filtered oil into an internal combustion engine and, more particularly, to an oil filter designed to be completely sealed by an assemblage of a bottom plate with a filter housing, thus being free from a seaming cap conventionally provided at the top of the filter, the oil filter free from such a conventional seaming cap being thus improved in its filtering performance, and being effectively produced using a reduced amount of material through a simplified production process requiring fewer man-hours, and thereby being reduced in its production cost, the oil filter also simplifying the construction of the filter production system, and being improved in productivity. The present invention also relates to a method of manufacturing such oil filters.

2. Description of the Prior Art

As well known to those skilled in the art, a plurality of processes and techniques have been used for forming the sealing flange on the housing of an oil filter for internal combustion engines.

FIGS. 1 to 3b show a conventional process of forming a sealing flange on the housing of an oil filter for internal combustion engines, and the construction of the housing with the completely formed sealing flange.

As shown in the drawings, the conventional process of producing an oil filter 100 for internal combustion engines includes a pre-assembling process consisting of the first step of forming a bottom plate 110, the second step of forming a seaming cap 120, the third step of integrating the bottom plate 110 with the seaming cap 120 into a single body through a spot welding process, and the fourth step of closely fitting an elastic packing ring 102b into a depressed annular packing seat 121 formed on the top of the seaming cap 120. After the packing ring fitting step, the integrated body, comprising the bottom plate 110 and the seaming cap 120, is fed to a next process, that is, a main assembling process 30.

In the main assembling process, a support spring 140 and a filtering element 130 are primarily set within a filter housing 101 at predetermined places. Thereafter, the seaming cap 120 integrated with the bottom plate 120 is positioned at the top of the housing 101 prior to forming a sealing flange. The conventional process of producing such oil filters is ended at the step of forming the sealing flange.

That is, in order to produce a conventional oil filter 100, the seaming cap 120 is primarily mounted to the bottom plate 110 through a spot welding process, and is seamed to the filter housing 101 as shown in FIGS. 2 to 3b. In the prior art, it has been considered that only the seaming cap 120 can be assembled with the filter housing 101 during the process of producing the oil filters for internal combustion engines. Therefore, the process of assembling the seaming cap 120 with the filter housing 101 has to be carried out even though this process undesirably reduces productivity of such oil filters.

As shown in FIG. 3b, the conventional filtering element 130 is produced by applying a conventional adhesive, preferably, liquid PVC solution “PS”, on the upper and lower lids 131a and 132a at predetermined positions, and positioning a filtering paper 134 between the upper and lower lids 131a and 132a. Thereafter, the liquid PVC solution “PS” is properly hardened to form upper and lower adhesive parts 131 and 132 at the junctions of the filtering paper 134 and the two lids 131a and 132a. In the conventional filtering element 130, the filtering paper 134 has an effective filtering area designated by the dimension “h” in FIG. 3b.

However, the conventional process of manufacturing the oil filters for internal combustion engines is problematic in that it requires a separate complex facility used for assembling the seaming cap with the filter housing, thus finally forcing the owner of the oil filter manufacturing system to pay excessive money for the system.

In addition, it is very difficult to form the sealing flange during the conventional oil filter manufacturing process, and so the resulting oil filters may fail to have desired high quality and may waste materials.

The seaming cap also forces the manufacturer of oil filters to waste excessive labor, increases the production time, and reduces productivity during the process of manufacturing the oil filters, thus finally increasing the production cost of the oil filters.

In addition, the worker may be frequently injured at his hands by the sharpened edge of the flange of the seaming cap during the process of fitting the elastic packing ring into the depressed annular packing seat of the seaming cap. It is thus necessary to provide a means for protecting workers from such sharpened edges of the seaming caps.

In the conventional oil filters, the hardened adhesive parts, formed at the junctions of the filtering paper and the upper and lower lids of the filtering element, may be easily broken to allow an undesired leakage of oil from the filtering element through the broken adhesive parts. When the adhesive parts of the filtering element are broken as described above, the oil filter cannot accomplish its desired filtering function, and has to be replaced with a new one without being used for an expected lengthy period of time.

Another problem, experienced in the conventional oil filters, resides in that the adhesive parts of the filtering element reduce the effective filtering area of the filtering paper, thus forcing the filtering element to be provided with a large-size filtering paper for accomplishing a desired filtering effect.

### SUMMARY OF THE INVENTION

Accordingly, the present invention has been made keeping in mind the above problems occurring in the prior art, and an object of the present invention is to provide an oil filter for internal combustion engines, which is designed to be effectively and completely sealed by an easy and simple assemblage of a bottom plate with a filter housing, thus being free from a conventional seaming cap and being effectively produced using a reduced amount of material through a simplified production process requiring fewer man-hours, and thereby being reduced in its production cost, and which also simplifies the construction of the filter production system, and is improved in productivity.

Another object of the present invention is to provide an oil filter for internal combustion engines and a method of manufacturing such filters, which protects workers from safety hazards during the process of producing the filters.

A further object of the present invention is to provide an oil filter for internal combustion engines and a method of manufacturing such filters, which almost completely prevents unexpected leakage of oil from a filtering element through the upper and lower adhesive parts, thus allowing the filtering element to perform its desired filtering function for an expected lengthy period of time and feeding desirably filtered oil to an engine, and thereby protecting the engine from any impurities of the oil.

Still another object of the present invention is to provide an oil filter for internal combustion engines and a method of manufacturing such filters, which is designed to enlarge the effective filtering area of the filtering element, thus allowing the filtering element to accomplish a desired filtering effect using a small-size filtering paper.

In order to accomplish the above objects, the present invention provides an oil filter, detachably assembled with a filter head of an internal combustion engine and used for filtering contaminated oil from the engine using its filtering element prior to feeding filtered oil to the engine, comprising: a circular bottom plate assembled with the filter head, the bottom plate having: one or more oil inlet holes formed on the bottom plate and used for introducing the contaminated oil from the engine into the oil filter; an annular packing seat formed on the bottom plate at a position outside the oil inlet holes and used for seating a packing ring therein, thus allowing the packing ring to prevent a leakage of oil from the oil filter, with inside and outside annular dams formed along opposite edges of the packing seat and used for stably holding opposite sides of the packing ring, thus preventing the packing ring from being undesirably moved on the bottom plate due to inlet oil pressure; an outside flange horizontally formed along the outside edge of the bottom plate; and an oil outlet hole formed on the bottom plate at a central portion and mounted to the filter head by a locking means, the oil outlet hole being also used for feeding filtered oil from a core of the filtering element to the engine; and a filter housing tightly assembled with the bottom plate into a single body through a seaming process, in which the horizontally stepped top edge of the filter housing primarily engages with the horizontal outside flange with another packing ring being interposed between the horizontal outside flange of the bottom plate and the horizontal step of the filter housing, and is bent to tightly cover the upper surface of the outside flange of the bottom plate, thus forming a sealing flange preventing a leakage of contaminated oil from the oil filter through the seamed junction of the bottom plate and the filter housing.

The present invention also provides a method of manufacturing an oil filter, comprising: a primary assembling step of vertically setting a support spring within a drawn filter housing of a predetermined depth at a predetermined position, and setting a relief valve and a cored filtering element within the filtering housing at positions above the support spring, thus allowing the relief valve and the filtering element to be supported by the support spring; a bottom plate forming step of punching a metal sheet to form a disc-shaped plate body, piercing the plate body to form both an oil inlet hole and a central hole, primarily forming an oil outlet hole at the central hole of the plate body by a first forming die descending above a support die stably inserted into the central hole of the plate body, and forming a specifically embossed pattern on the bottom plate by both an embossed lower surface of a descending second forming die and an embossed upper surface of a fixed die; and a main assembling step of laying the filter housing in a central bore of a lower die by seating a horizontal step of the filter housing on the top edge of the bore, seating the bottom plate on the horizontal step of the filter housing with both a first packing ring laid between an outside flange of the bottom plate and the horizontal step of the filter housing and a second packing ring laid on the bottom plate at a predetermined position, compressing the bottom plate using a compression die to accomplish a sealing effect of the second packing ring and to set a position of the bottom plate on the filter housing, descending a first compression die surrounding the compression die, and bending the top edge of the filter housing by moving a flange-forming die to allow the top edge to cover the outside flange of the bottom plate, thus forming a sealing flange.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram, showing a conventional process of producing oil filters for internal combustion engines;

FIG. 2 is a sectional view of a conventional oil filter for internal combustion engines;

FIG. 3a is a sectional view of the portion “A” of FIG. 2, showing the assembling structure of a bottom plate with a seaming cap of the conventional oil filter;

FIG. 3b is a sectional view of a conventional filtering element, showing the construction of upper and lower lids and upper and lower adhesive parts of the filtering element;

FIGS. 4a and 4b are views, showing the appearance and cross-section of an oil filter for internal combustion engines in accordance with the preferred embodiment of the present invention;

FIGS. 5a to 5c are sectional views, showing the process of forming a bottom plate of the oil filter according to the present invention;

FIGS. 6a to 6d are sectional views of the portion “B” of FIG. 4b, showing the assembling structures of the bottom plate with a filter housing of the oil filter in accordance with different embodiments of the present invention;

FIGS. 7 and 8 are sectional views, showing the operation of a system for assembling the bottom plate with the filter housing while sealing the assembled junction of the plate and the housing, and showing the process of assembling the bottom plate with the filter housing, wherein FIG. 7 shows the first step of pressing the top of the bottom plate, and FIG. 8 shows the second step of forming a sealing flange of the filter housing and of completely assembling the housing with the bottom plate;

FIG. 9 is a plan sectional view taken along the line C-C of FIG. 8, showing a flange-forming press used for forming the sealing flange of the filter housing in the process of this invention;

FIG. 10 is a sectional view, showing a process of forming the sealing flange of the filter housing in accordance with another embodiment of the present invention;

FIG. 11 is a sectional view, showing a process of forming the sealing flange of the filter housing in accordance with a further embodiment of the present invention;

FIG. 11a is a view of the portion of “D” of FIG. 11, showing the forming process of a first forming roller in detail;

FIGS. 12a and 12b are sectional views, showing a process of forming the sealing flange of the filter housing in accordance with still another embodiment of the present invention;

FIGS. 13a to 13c are sectional views, showing the process of forming the upper and lower adhesive parts of a filtering element included in the oil filter of the present invention;

FIGS. 14a to 14c are views, showing the process of forming the upper and lower adhesive parts of a filtering element in accordance with another embodiment of the present invention;

FIG. 15 is a plan view of the filtering paper used in the filtering element of FIGS. 14a to 14c; and

FIG. 16 is a block diagram, showing the process of producing the oil filters in accordance with the preferred embodiment of the present invention.

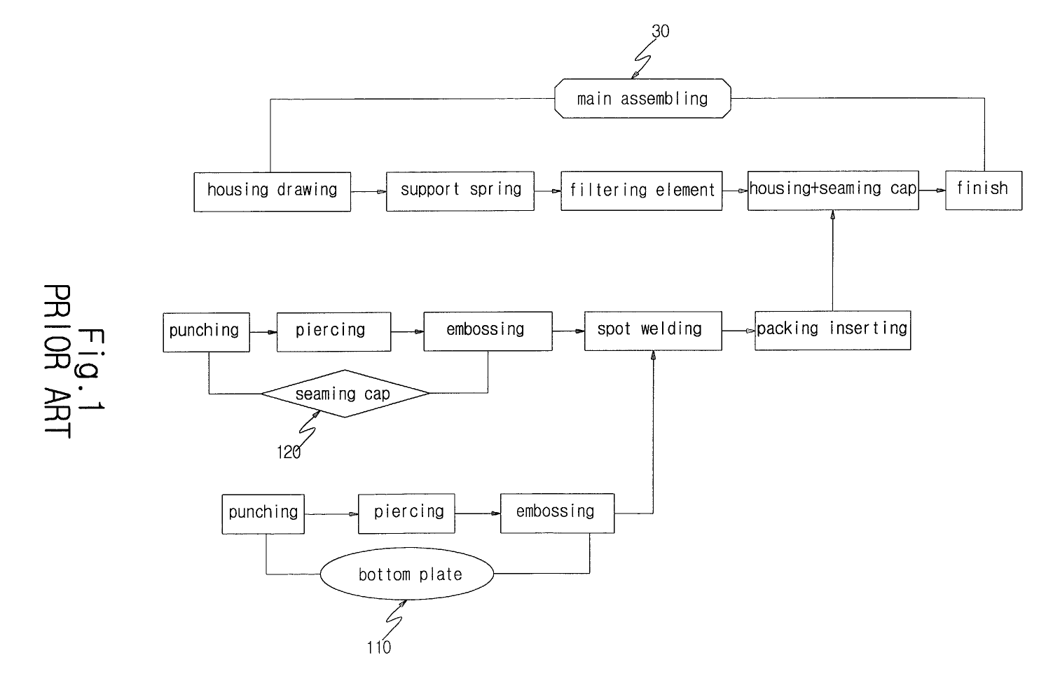

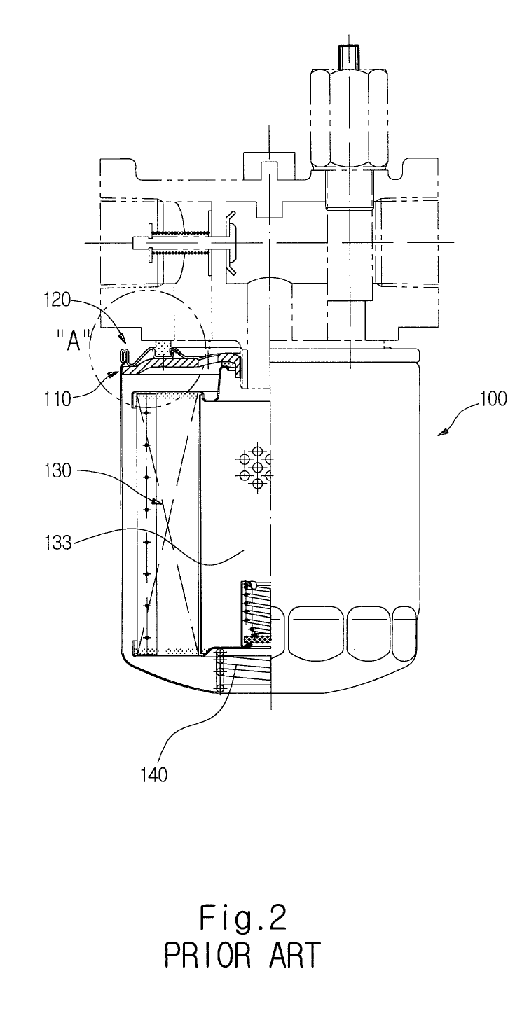

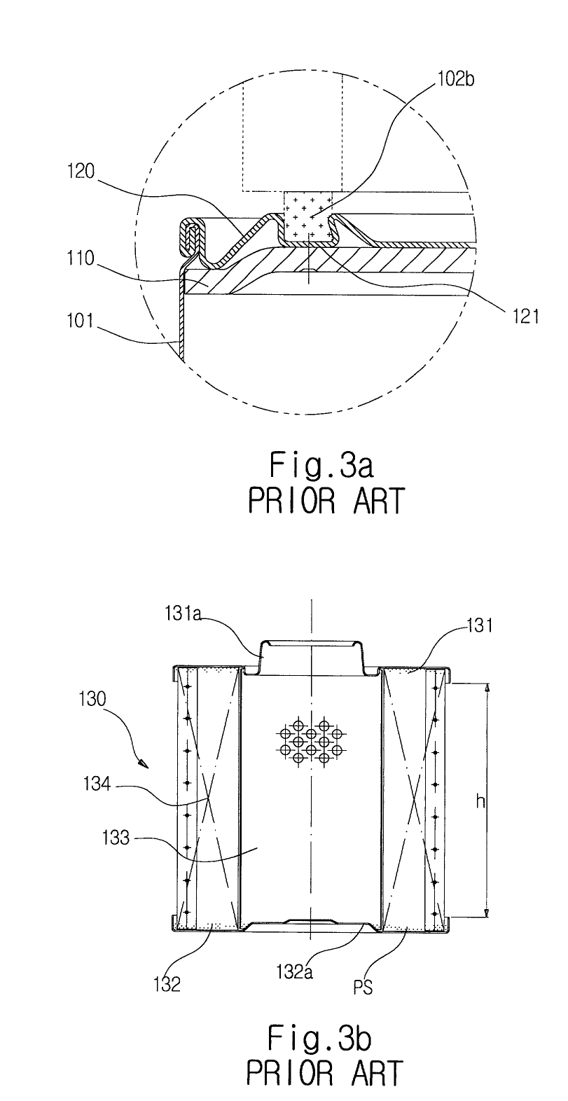

### DETAILED DESCRIPTION OF THE INVENTION

Reference now should be made to the drawings, in which the same reference numerals are used throughout the different drawings to designate the same or similar components.

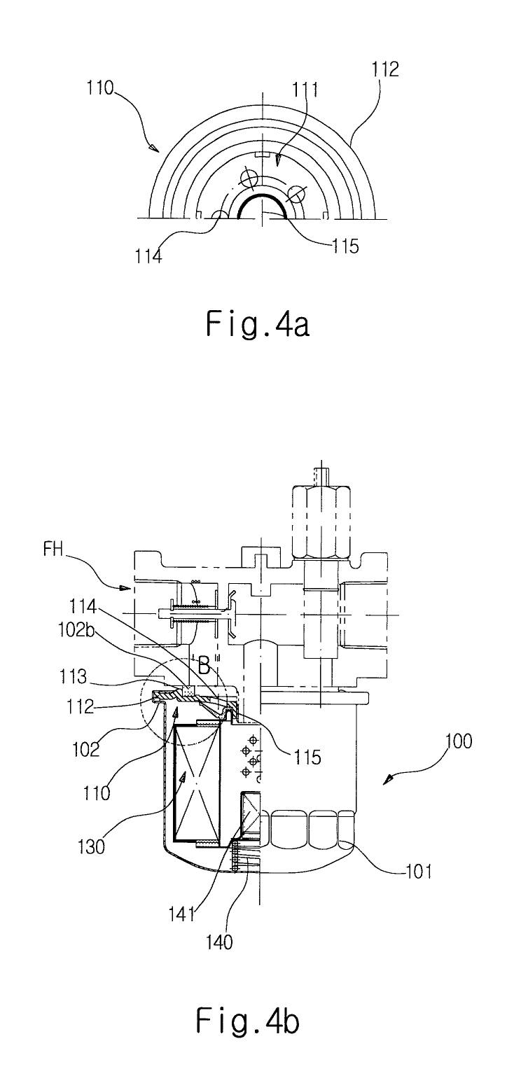

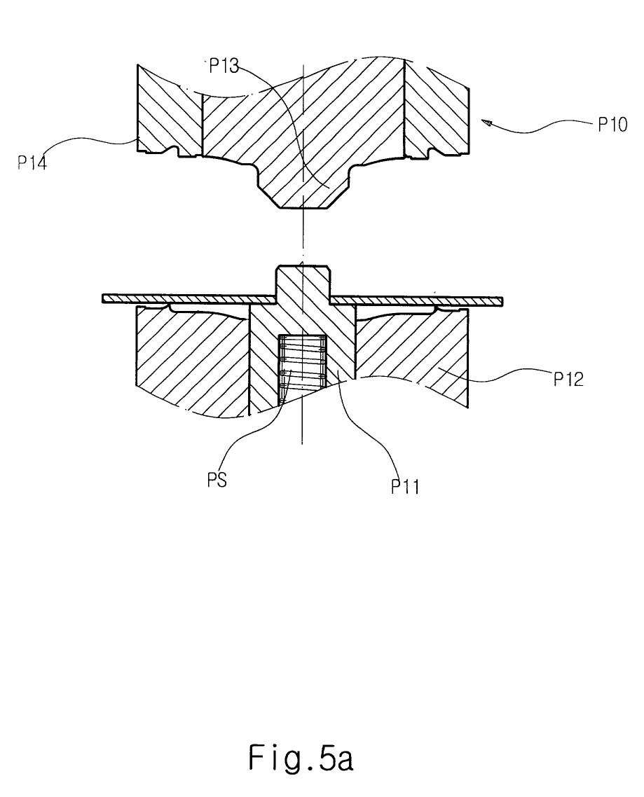

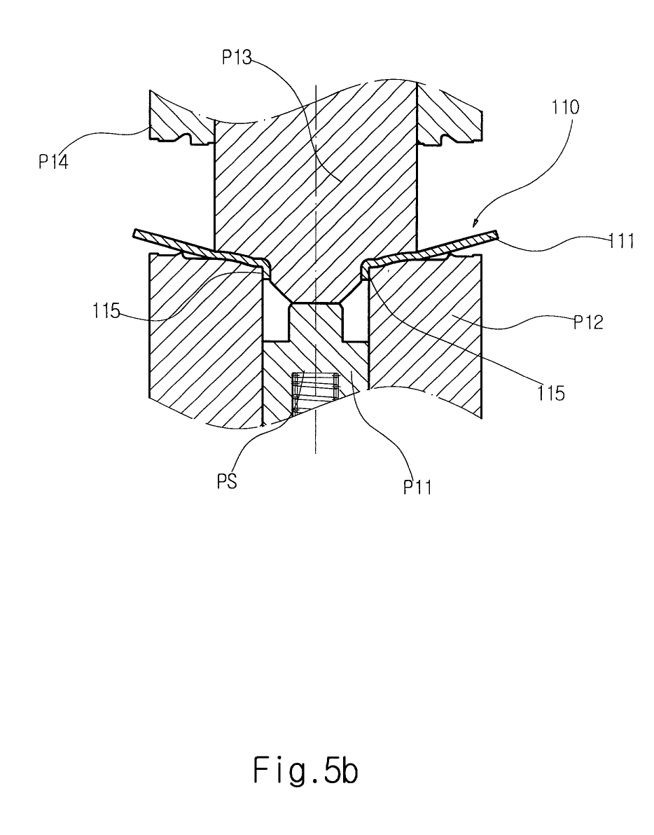

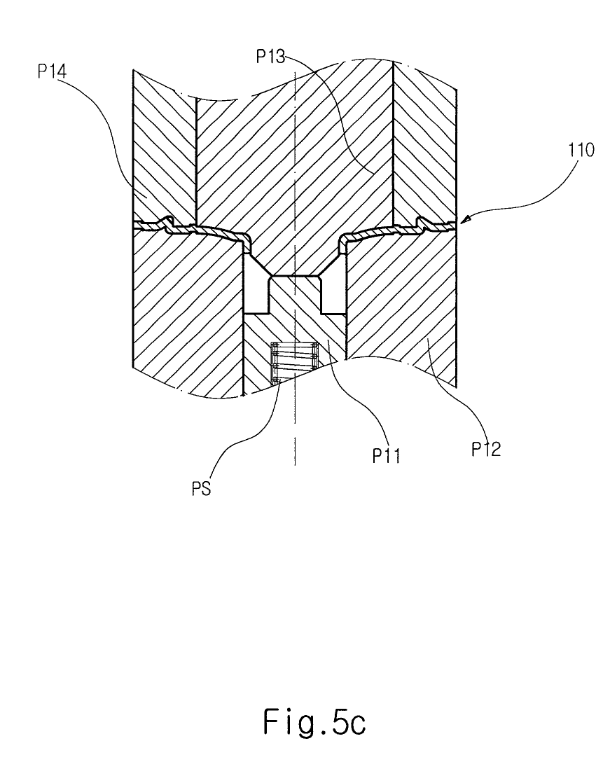

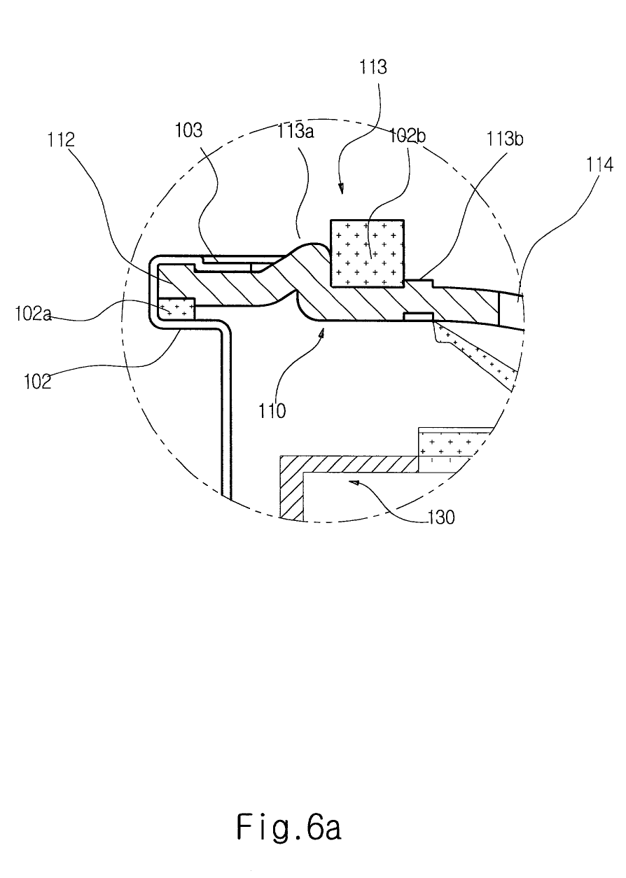

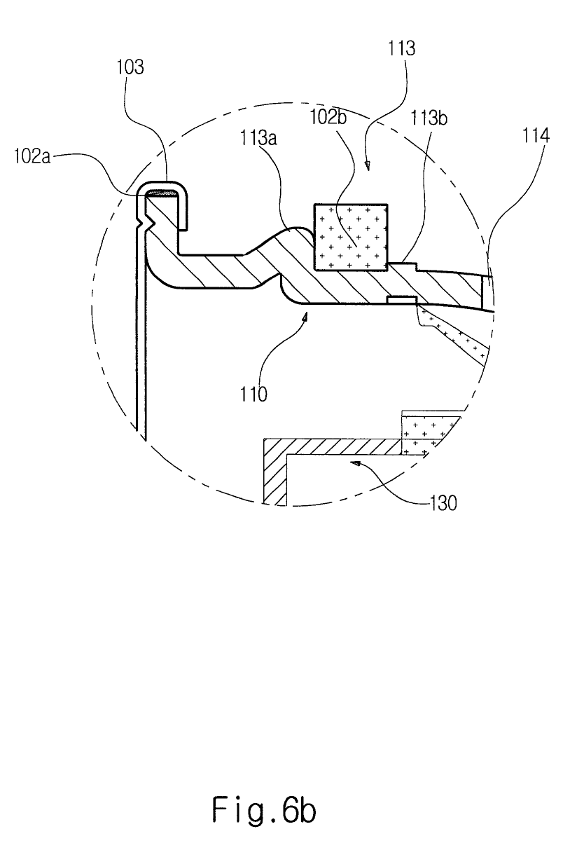

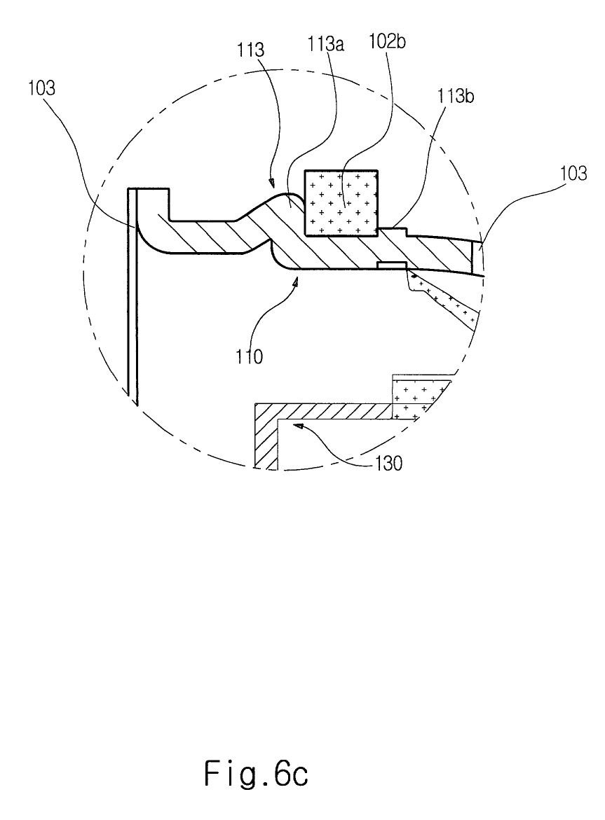

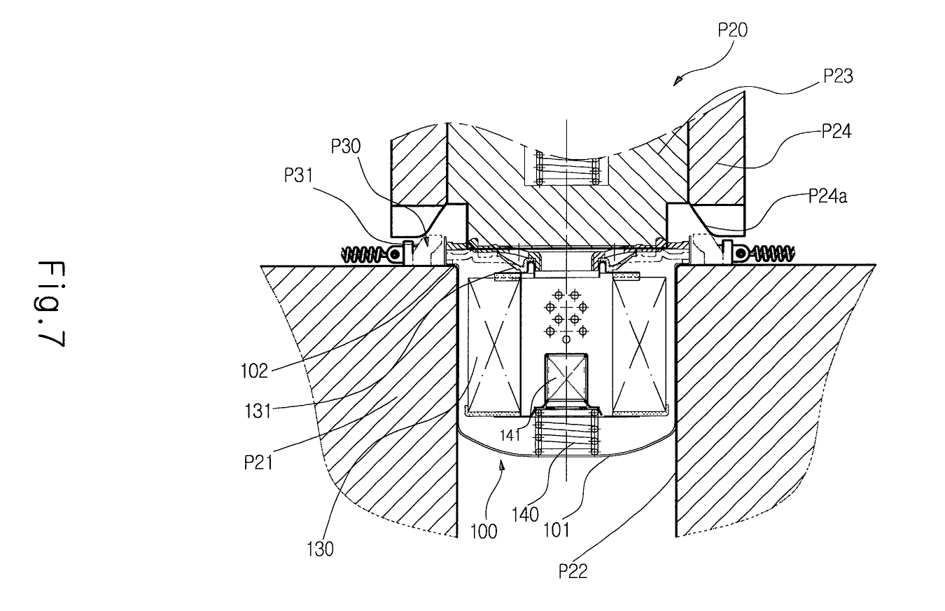

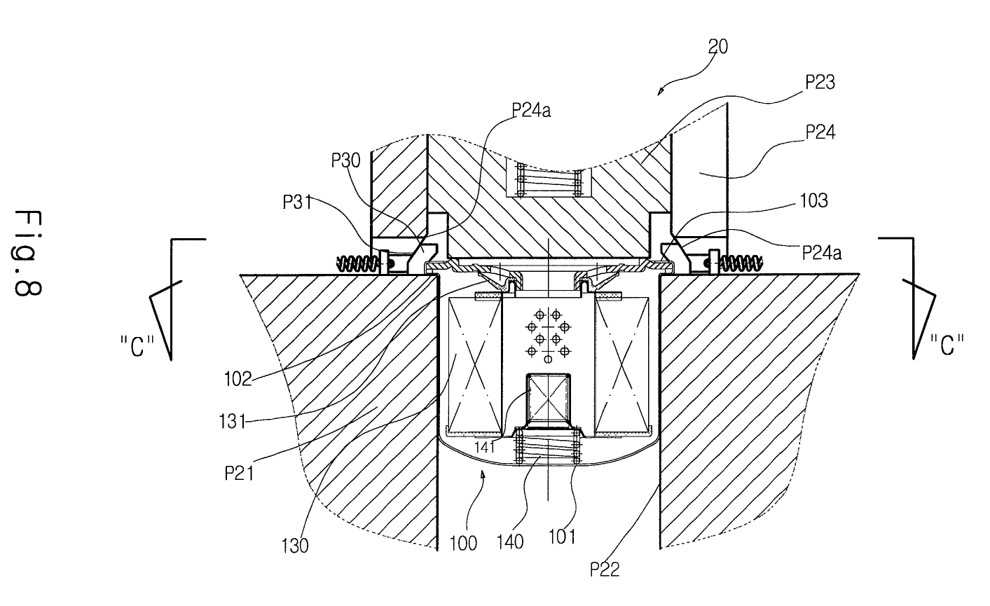

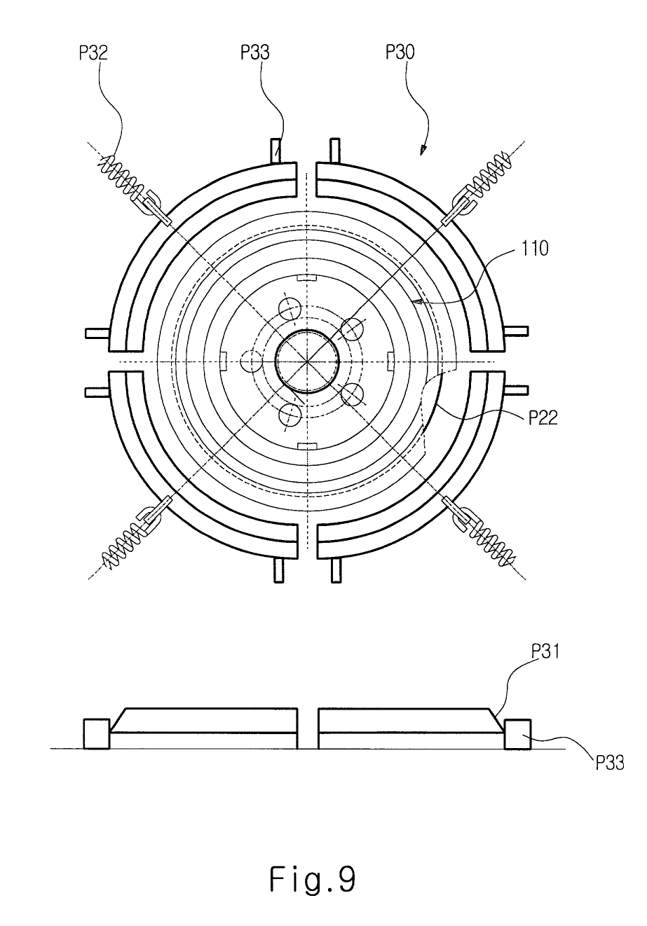

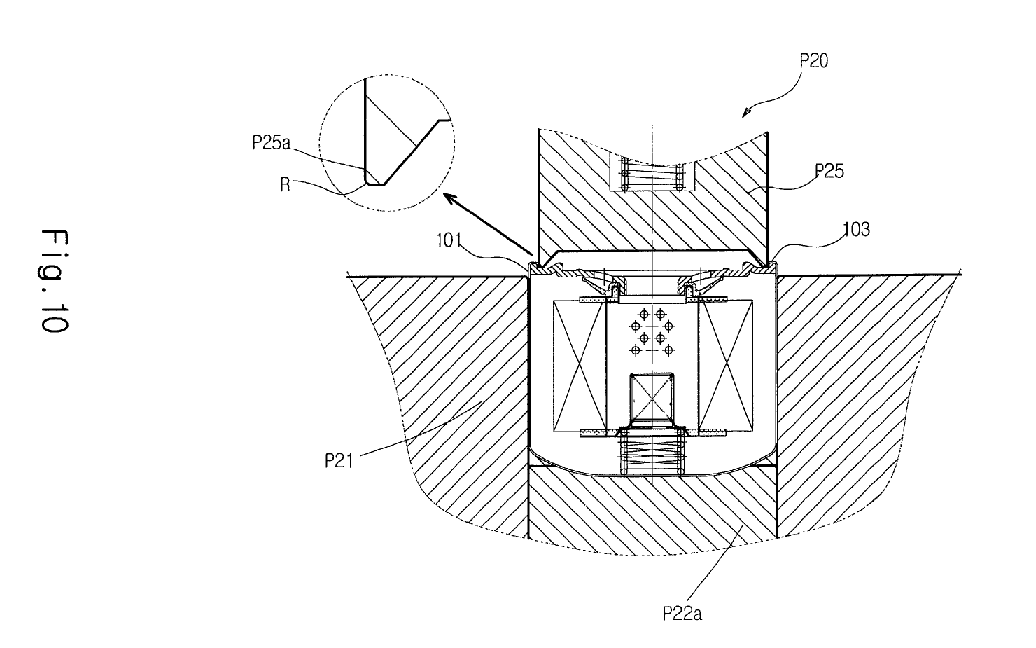

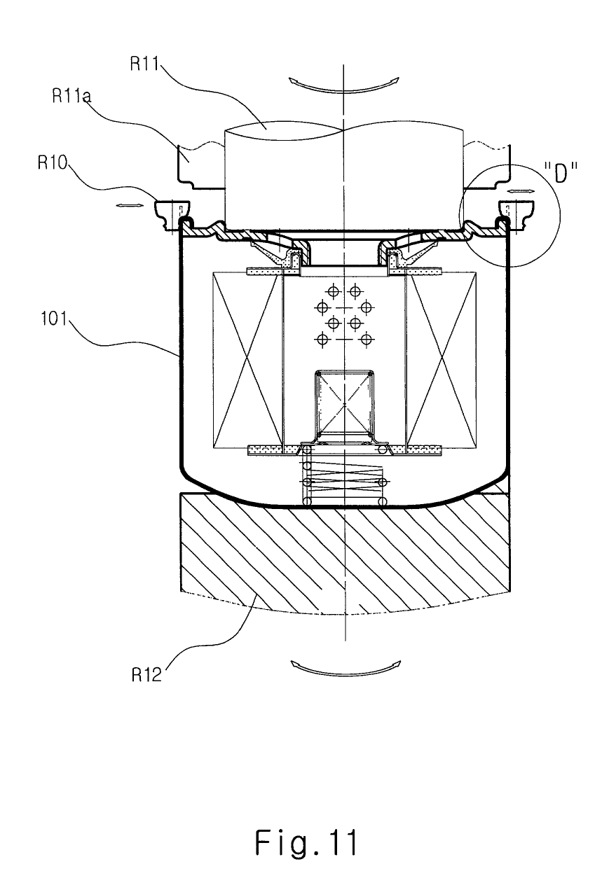

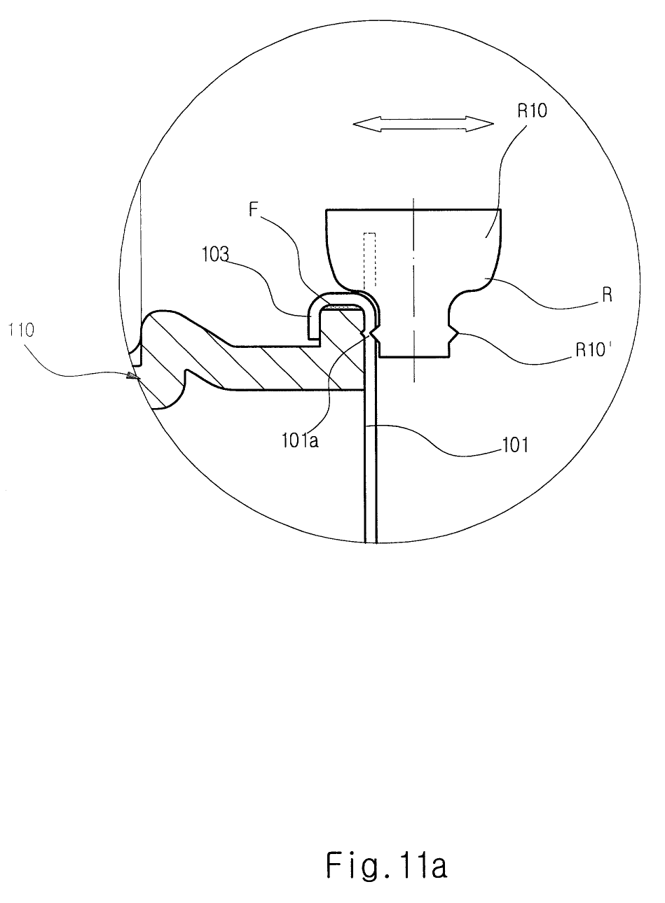

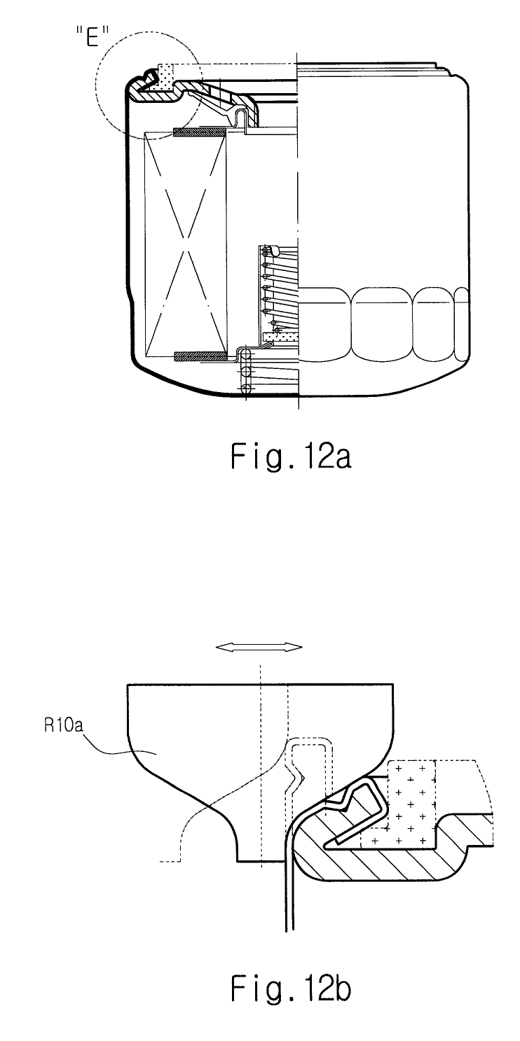

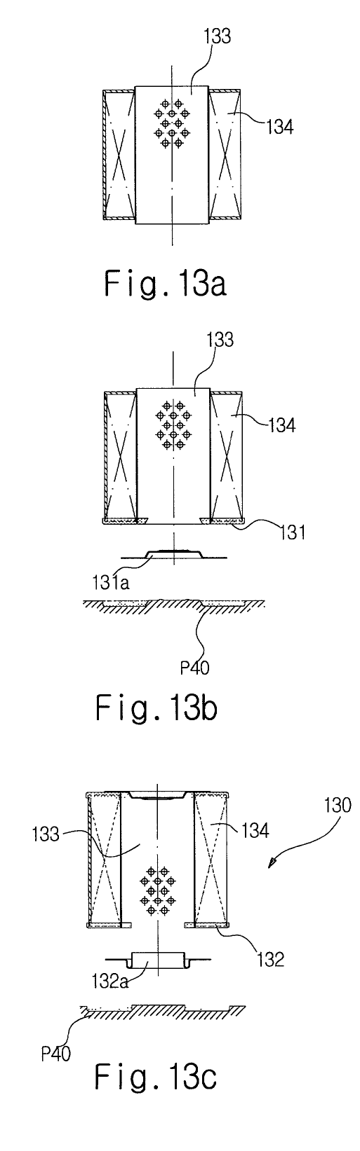

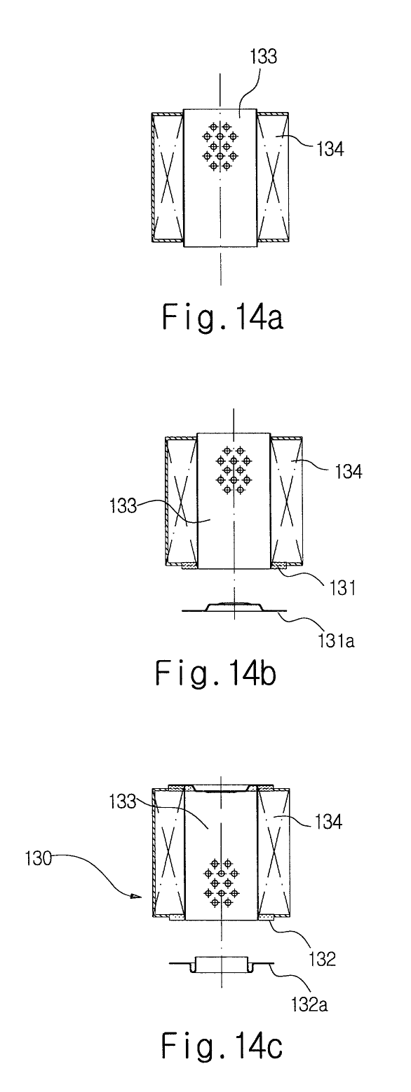

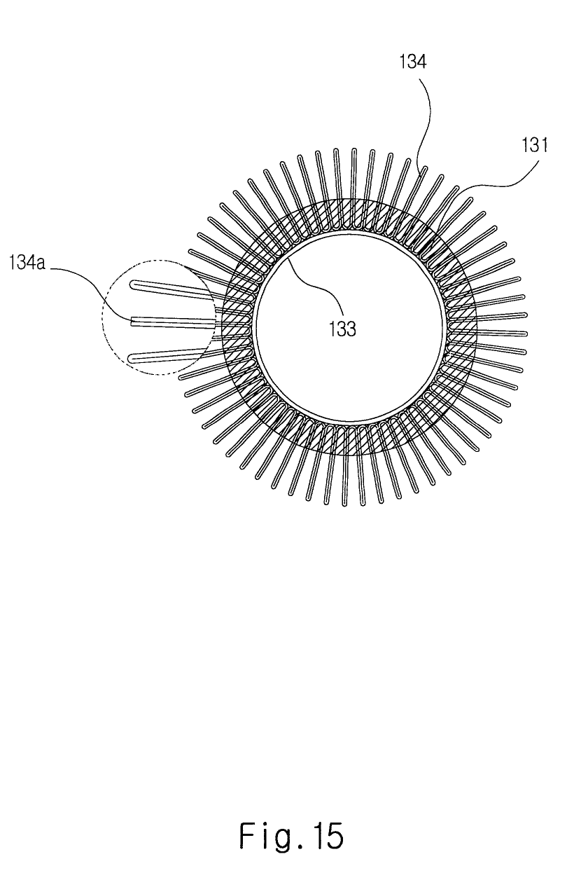

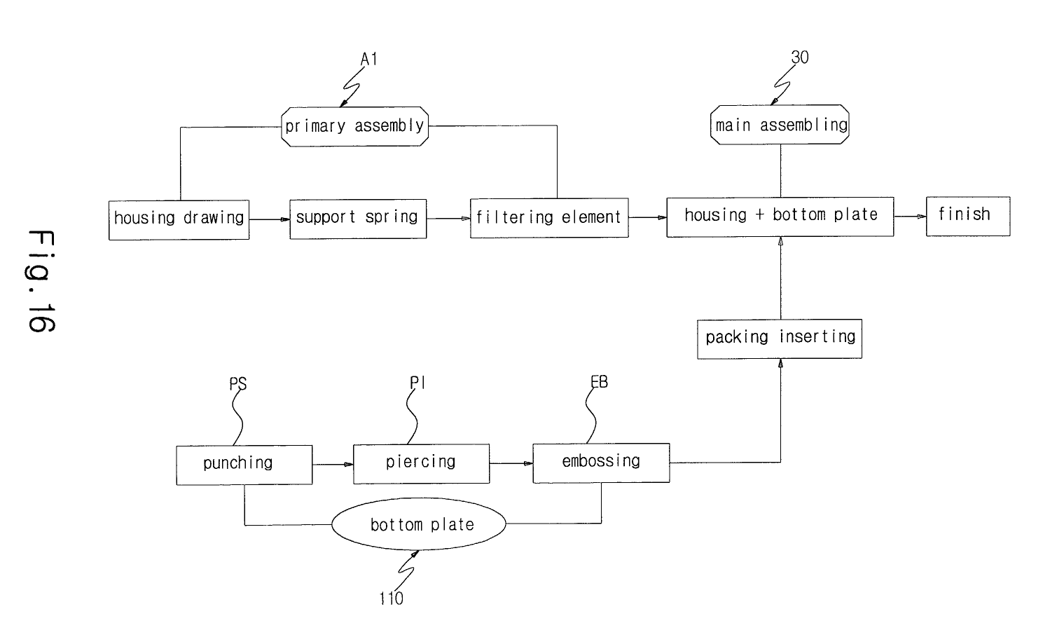

FIGS. 4a and 4b show an oil filter for internal combustion engines in accordance with the preferred embodiment of this invention. FIGS. 5a to 5c show the process of forming a bottom plate of the oil filter. FIGS. 6a to 6d are sectional views of the portion “B” of FIG. 4b, showing the assembling structures of the bottom plate with a filter housing. FIG. 7 shows the first step of pressing the top of the bottom plate in the process of this invention. FIG. 8 shows the second step of forming a sealing flange of the filter housing and completely assembling the housing with the bottom plate in the manufacturing process of this invention. FIG. 9 is a plan sectional view taken along the line C-C of FIG. 8, showing a flange-forming press used for forming the sealing flange of the filter housing in the manufacturing process of this invention. FIG. 10 shows the process of forming the sealing flange of the filter housing in accordance with another embodiment of this invention. FIG. 11 shows the process of forming the sealing flange of the filter housing in accordance with a further embodiment of this invention. FIG. 11a is a view of the portion of “D” of FIG. 11, showing the forming process of a first roller in detail. FIGS. 12a and 12b show the process of forming the sealing flange of the filter housing in accordance with still another embodiment of this invention. FIGS. 13a to 13d show the process of forming the upper and lower adhesive parts of a filtering element included in the oil filter of this invention. FIGS. 14a, 14b, 14c and 15 show filtering elements and upper and lower adhesive parts of the filtering elements in accordance with different embodiments of this invention. FIG. 16 is a block diagram, showing the process of producing the oil filters in accordance with the preferred embodiment of this invention.

The operation of a conventional oil filter will be described in brief prior to describing in detail the construction and operation of the oil filter 100 according to the present invention.

As well known to those skilled in the art, engine oil is contained in the oil pan provided at the lower portion of an internal combustion engine, and is sprayed into the cylinders of the engine by an eccentrically rotated crank rod mounted to a crankshaft cooperating with a flywheel, and is used to lubricate the junctions of the reciprocating pistons and the internal surfaces of the cylinder bores. During an operation of the engine, the oil is contaminated with a variety of impurities, such as metal powders, created by the frictional movement of the reciprocating pistons within the cylinder bores, dust, carbons and resins formed by combustion of fuel within the cylinder bores. The oil contaminated with impurities returns to the oil pan.

The contaminated oil is, thereafter, pumped from the oil pan while being pressurized to a predetermined pressure set by an oil pressure switch, and is fed to an oil filter 100 through a filter head.

Within the oil filter 100, the contaminated oil is filtered by a filtering element 130, and so the impurities are removed from the oil. The filtered oil is, thereafter, fed from the oil filter 100 to the engine so as to lubricate the junctions of the reciprocating pistons and the internal surfaces of the cylinder bores.

As shown in FIG. 4b, the oil filter 100 according to the present invention comprises a bottom plate 110, which is provided at the top of the filter 100 and is mounted to the bottom of the filter head FH by a locking screw. In such a case, a second packing ring 102b is closely interposed between the filter head FH and the bottom plate 110, and prevents a leakage of contaminated oil from the junction of the filter head FH and the bottom plate 110.

In such a case, the second packing ring 102b is preferably made of an elastic material capable of resisting fire, and so it is possible to control the sealing effect of the packing ring 102b by controlling the tightening strength of the locking screw.

In order to stably seat the packing ring 102b at the junction of the filter head FH and the bottom plate 110, a depressed annular packing seat 113 is formed on the top surface of the bottom plate 110. The bottom plate 110, provided at the top of the oil filter 100, comprises a circular plate body 111, with a sealing flange 112 formed along the outside edge of the plate body 111 and tightly seamed to the upper end of the filter housing 101, thus having a seaming function provided by a conventional seaming cap 120. In the present invention, the sealing flange 112 is embodied differently to have different shapes as will be described herein later, but the sealing flange is designated by the reference numeral 112 regardless of the different embodiments.

The annular packing seat 113, having first and second annular dams 113a and 113b along its opposite edges, is formed on the top surface of the bottom plate 110 at positions inside the sealing flange 112, and stably seats the packing ring 102b therein without allowing the ring 102b to undesirably move on the plate 110. In order to prevent the packing ring 102b from being thrust outward by the pressure of oil within the filter 100, the height of the first dam 113a formed along the outside edge of the seat 113 is higher than that of the second dam 113b formed along the inside edge of the seat 113.

That is, the first dam 113a is designed to have a height capable of almost completely preventing the packing ring 102b from being undesirably thrust outward by the pressure of oil.

A plurality of inlet holes 114 are formed on the bottom plate 110 at positions inside the seat 113, thus allowing oil under pressure to be smoothly introduced from the filter head FH into the oil filter.

The circular plate body ill of the bottom plate 110 is produced through a pressing process using a press. This plate body 111 has the above-mentioned oil inlet holes 114 in addition to an oil outlet hole 115, through which the bottom plate 110 is mounted to the filter head FH using the locking screw.

FIGS. 5a to 5c are sectional views, showing the process of forming the bottom plate 110 of the oil filter of this invention using a press P10.

As shown in the drawings, a fixed die P12 is fixedly placed at a lower position of the press P10, and is provided with a vertical support hole at its center. A support die P11 is movably fitted into the support hole of the fixed die P12. The plate body 111 of the bottom plate has a central hole, which becomes a desired oil outlet hole 115 through a pressing process. During the pressing process, the plate body 111 is seated on a holder provided at the top of the support die P11 at the central hole, thus being prevented from undesirably moving during the pressing process. Of course, since the plate body 111 has a circular shape, it is possible to concentrically support the centrally holed plate body 111 on the top of the support die P11.

The support die P11 is supported by a compression coil spring PS at its lower portion, thus being normally biased upwardly in a vertical direction. The compression coil spring PS absorbs impact applied from a first forming die P13 in the case of a descending action of the die P13 during the pressing process. The descending forming die P13 primarily forms the oil outlet hole 115 on the concentrically supported plate body 111 through a burring process. The resulting bottom plate 110 is mounted to the filter head FH at the oil outlet hole 115.

During the pressing process, the pumping press P10 secondarily forms a desired embossed pattern on the plate body 111 by compressing the plate body 111 between the specifically embossed upper surface of the fixed die P12 and the specifically embossed lower surface of a vertically movable second forming die P14.

The bottom plate 110 of this invention, having the packing seat 113 in addition to the oil outlet hole 115 and designed to collaterally act as a conventional seaming cap, is produced quickly through a one-stroke pressing process using the press P10.

FIGS. 6a to 6d are sectional views of the portion “B” of FIG. 4b, showing the assembling structures of the bottom plate 110 with the filter housing 101 in accordance with different embodiments of the present invention.

In the embodiment of FIG. 6a, a conventional press, provided with a flange-forming press P20 of FIG. 7, is used for bending the top edge of the housing 101 to form a desired sealing flange 103 closely covering the sealing flange 112 of the bottom plate 110.

In said embodiment, a horizontal step 102 is formed along the top edge of the housing 101, with a first packing ring 102a being closely positioned between the internal surface of the horizontal step 102 and the lower surface of the sealing flange 112 of the bottom plate 110. The first packing ring 102a thus prevents a leakage of contaminated oil from the filter housing 101.

In such a case, the first packing ring 102a is compressed by the sealing flange 112 of the bottom plate 110, and so it retains its desired sealing effect. The compressing action of the sealing flange 112 on the first packing ring 102a will be described in more detail with reference to FIGS. 7 and 8.

In the embodiment of FIG. 6b, the filter housing 101 is not provided with the above-mentioned horizontal step 102 different from the embodiment of FIG. 6a, and is rolled at its top edge by a forming roller R10 of FIG. 11 to form a desired sealing flange 103. That is, the circular bottom plate 110 is bent upwardly along its outside edge to form a sealing flange 112. The filter housing 101 is rolled along its top edge by the forming roller R10, thus forming the sealing flange 103 closely covering the sealing flange 112 of the bottom plate 110, with a first packing ring 102a being closely interposed between the two sealing flanges 103 and 112.

In the embodiment of FIG. 6c, the circular bottom plate 110 is bent upwardly along its outside edge to form a sealing flange 112 in the same manner as that described for the embodiment of FIG. 6b. The bottom plate 110 is closely fitted into the top edge of the filter housing 101 prior to being integrated together into a single body through a laser welding process.

The processes of integrating the filter housing 101 and the bottom plate 110 into a single body according to the above-mentioned embodiments will be described in more detail herein below.

As shown in FIGS. 7 and 8, the flange-forming press P20 of this invention has a lower die P21 provided with a central bore P22. In the pressing process of forming the sealing flange 103 for integrating the bottom plate 110 with the filter housing 101, the housing 101 is primarily positioned in the bore P22 by seating the horizontal step 102 of the housing 101 on the top edge of the bore P22. In such a case, it is preferable to seat the housing 101 in the bore P22 while retaining an annular gap between the external surface of the housing 101 and the internal surface of the bore P22. This annular gap allows the oil filter 100 to be easily removed from the bore P22 of the lower die P21 after the pressing process of forming the sealing flange 103.

After the housing 101 is seated in the bore P22 of the lower die P21 as described above, a variety of elements of the oil filter 100, for example, a support spring 140, a relief valve 141, a filtering element 130 and a rubber valve 150, are set within the housing 101 at predetermined positions.

Of course, it should be understood that the housing 101 may be seated in the bore P22 of the lower die P21 after the elements of the oil filter 100 are completely set within the housing 101.

Thereafter, the first packing ring 102a is seated on the horizontal step 102 of the housing 101 seated on the top edge of the bore P22. The bottom plate 110 is seated on the housing 101 in such a way that the sealing flange 112 of the bottom plate 110 is positioned on the first packing ring 102a. In the same manner as that described for the second packing ring 102b, the first packing ring 102a is preferably made of an elastic material capable of resisting fire and oil.

In such a case, the elements, set within the housing 101 and held by the support spring 140, are positioned above the horizontal step 102 of the housing 101, and so the flange-forming press P20 of this invention is operated through a two-step process.

During the two-step process of forming the sealing flange of the oil filter, the first step of the process is carried out to adjust the level of the elements positioned above the horizontal step 102 of the housing 101.

As shown in the drawings, the compression die P23 provided at the center of the upper die presses the top surface of the bottom plate 110, thus appropriately compressing the second packing ring 102b laid in the packing seat 113 of the bottom plate 110 and accomplishing a desired sealing effect of the packing ring 102b. In addition, the position of the bottom plate 110 is appropriately set so as to allow the second step of the process to be easily performed.

As shown in FIGS. 8 and 9, when the position of the bottom plate 110 is completely set as described above, the first compression die P24 surrounding the compression die P23 directly moves downward in a vertical direction. In addition, the flange-forming die P30, provided on the top of the lower die P21, is moved forward to form a desired sealing flange 103 of the housing 101. The forward movement of the flange-forming die P30 will be described in more detail with reference to FIG. 9.

FIG. 9 is a plan sectional view taken along the line C-C of FIG. 8, showing the flange-forming die P30 of the press P20 used for forming the sealing flange of the filter housing in the flange forming process of this invention.

As shown in the drawing, the flange-forming die P30 is positioned around the top edge of the housing 101. This die P30 comprises four arc-shaped pieces, each of which is normally biased backward by a tension coil spring P32.

Two stoppers P33 are provided around each of the four pieces of the flange-forming die P30 at positions outside the tension coil spring P32, thus maintaining an initial position of each piece of the die P30. The flange-forming die P30 in such an initial position forms a central opening, thus allowing the filter housing 101 to be smoothly seated in the bore P22 of the lower die P21 through the central opening.

Thereafter, a variety of elements of the oil filter 100, such as the support spring 140, are set within the housing 101 prior to moving the upper die downward in a vertical direction. When the upper die is moved downward as described above, the compression die P23 of the upper die presets the position of the bottom plate 110 on the housing 101.

In such a case, the inclined part P24a of the first compression die P24 comes into contact with the inclined part P31 of the flange-forming die P30, thus allowing the flange forming die P30 to move forward by a width defined by the angles of inclination of the two inclined parts P24a and P31. The flange-forming die P30 thus bends the top edge of the housing 101 to form the desired sealing flange 103 such that it closely and firmly covers the outside edge of the bottom plate 110.

After the sealing flange 103 of the housing 101 is completely formed, both the compression die P23 and the first compression die P24 are moved upward in the vertical direction to return to their original positions. In such a case, the four pieces of the flange-forming die P30 are moved backward by the tension coil springs P32, thus returning to their initial positions. Thereafter, the resulting oil filter 100 is removed from the forming press P20.

FIG. 10 is a sectional view, showing a process of forming the sealing flange 103 of the filter housing 101 in accordance with another embodiment of the present invention. In this embodiment, the flange-forming press forms a desired sealing flange 103 on the top edge of the housing 101 free from a horizontal step 102, different from the embodiment of FIGS. 7 and 8.

In the embodiment of FIG. 10, the top edge of the housing 101 is bent at an angle of 90° by the flange-forming press P20, comprising the lower die P21, the compression die P23, the first compression die P24 and the flange-forming die P30, in the same manner as that described for the embodiment of FIGS. 7 and 8, and further explanation for the bending process is thus not deemed necessary.

However, in the embodiment of FIG. 10, a support block P22a is laid on the bottom surface of the bore P22 of the lower die P21, and is used for supporting the filter housing 101 within the bore P22. Due to the support block P22a, it is possible to prevent an undesired movement of the housing 101 within the bore P22.

In the embodiment of FIG. 10, the support block P22a may be not provided with a separate impact absorbing spring at its lower end, because the support block P22a can be effectively supported by the support spring 140 of the housing 101.

In the present invention, the support block P22a is separately produced, and is set within the bore P22. However, it should be understood that support block P22a may be integrated with the lower die P21 during the process of producing the flange-forming press P20.

Since the filter housing 101 is not provided with the horizontal step 102 different from the embodiment of FIGS. 7 and 8, it is impossible to initially lay the first packing ring 102a on the top edge of the housing 101. Therefore, the outside edge of the bottom plate 110 is bent upwardly to form a sealing flange 112 prior to laying a conventional packing means on the top edge of the sealing flange 112. Thereafter, the sealing flange 103 of the housing 101 is formed by a forward movement of the forming die P30 in the same manner as that described for the embodiment of FIGS. 7 and 8. The process of forming the sealing flange 103 of the housing 101 using the forming die P30 remains the same as that described for the embodiment of FIGS. 7 and 8, and further explanation is thus not deemed necessary.

In such a case, the first packing ring 102a may be used as the conventional packing means positioned on the top edge of the sealing flange 112 of the bottom plate 110. However, it should be understood that a conventional sealant may be applied along the top edge of the sealing flange 112 of the bottom plate 110 for ease of manufacturing.

The oil filter 100, of which the sealing flange 103 is primarily bent upwardly at an angle of 90° by the flange-forming die P30, is moved to a next bending stage as shown in FIG. 10, thus being secondarily bent inwardly at an angle of 90°, thus accomplishing a desired sealing effect.

The step of secondarily and inwardly bending the sealing flange 103 is performed by a second compression die P25. This second compression die P25 is provided with a circular depression at its lower surface, thus being free from any interference with the embossed pattern of the bottom plate 110 primarily set on the housing 101.

As best seen in FIG. 10, the outside edge of the lower surface of the second compression die P25 is appropriately rounded at a predetermined angle, thus having a rounded edge R. Due to the rounded edge R, the second compression die P25 easily and smoothly bends the sealing flange 103 inwardly without damaging the surface of the sealing flange 103. It is thus possible to completely form the sealing flange 103 of the housing 101 through a two-step process.

In addition, it is preferable to polish the forming part P25a of the second compression die P25, thus allowing the forming part P25a to have a smooth surface. Due to the smooth surface of the forming part P25a, the second compression die P25 does not damage the surface of the sealing flange, and prevents the resulting oil filter 100 from being fitted into the forming part P25a when the second compression die P25 moves upward after the flange forming process is finished.

FIG. 11 is a sectional view, showing a process of forming the sealing flange of the filter housing 101 so as to integrate the housing 101 with the bottom plate 110 into a desired oil filter 100 in accordance with a further embodiment of the present invention. As shown in the drawing, this embodiment is designed to form the desired sealing flange 103 using a seaming machine having a first forming roller R10 different from the embodiments of FIGS. 7 to 10 using the flange-forming press P20.

In the embodiment of FIG. 10, a lower rotary die R12 is provided at a lower portion of the seaming machine for supporting the bottom of the filter housing 101 during a flange forming process. In addition, a vertically movable upper rotary die R11 is provided at the upper position of the seaming machine for appropriately pressing the upper surface of the bottom plate 110, thus primarily setting the level of the bottom plate 110 on the housing 101.

When the level of the bottom plate 110 is set by the upper and lower rotary dies R11 and R12, the oil filter 100 is rotated, while the two first forming rollers R10 provided at opposite ends of the seaming machine are slowly moved inwardly relative to the seaming machine. Therefore, the first forming rollers R10, individually having a smoothly rounded forming surface, primarily bend the top edge of the filter housing 101, thus primarily forming a desired sealing flange 103 of the housing 101.

Thereafter, the first forming rollers R10 are moved outward to return to their original positions, while a forming rotary die R11a surrounding the outside edge of the upper rotary die R11 is moved downward in a vertical direction, thus secondarily or finally forming the sealing flange 103 of the housing 101.

As best seen in FIG. 11a, since the housing 101 is made of a metal having a high elongation ratio, the sealing flange 103 of the housing 101 is smoothly bent at an angle larger than the rounded angle of the rounded surface R of the first forming roller R10.

During the process of forming the sealing flange 103 of the housing 101 as described above, a conventional packing means is positioned at the junction of the bottom plate 110 and the filter housing 101 prior to bending the top edge of the housing 101 to form the sealing flange 103. The packing means is compressed by the sealing flange 103 to fill the cavity F defined by the sealing flange 103, thus accomplishing a desired sealing effect.

In addition, a projection R10′ is formed on the external surface of the first forming roller R10 at a lower position, and is used for forming a wedge groove 101a on the external surface of the top edge of the housing 101.

The formation of the above groove 101a is to prevent a leakage of contaminated oil from the junction of the housing 101 and the bottom plate 110, when the oil is not completely filtered by the filtering element 130 within the filter 100 and forms an excessive pressure within the filter 100.

FIGS. 12a and 12b are sectional views, showing a process of forming the sealing flange of the filter housing in accordance with still another embodiment of the present invention. This embodiment also uses a seaming machine in the same manner as that described for the embodiment of FIG. 11.

As shown in the drawing, the process according to this embodiment carries out the same steps of primarily and secondarily bending the top edge of the housing 101 in the same way as described for the embodiment of FIG. 11. However, in the embodiment of FIGS. 12a and 12b, the secondarily bent top edge of the housing 101, engaging with the sealing flange 112 of the bottom plate 110, is further bent at an angle of 90° or more using a second forming roller R10a, thus forming a sealing flange 103 of the housing 101 with a wedge groove 101a formed on the external surface of the sealing flange 103 as best seen in FIG. 12b. In the oil filter 100 produced through the process of FIGS. 12a and 12b, the bottom plate 110 accomplishes a desired sealing effect expected from the conventional seaming cap, and effectively prevents a leakage of oil from the oil filter. The embodiment of FIGS. 12a and 12b, thus provides a desired oil filter 100, which is free from the conventional seaming cap. This oil filter 100 is improved in its productivity, and is reduced in its production cost.

In the seaming machine of FIGS. 12a and 12b, two first forming rollers R10 and two second forming rollers R10a are positioned around the top edge of the filter 100 while being spaced apart from each other at an angle of 90°. When the forming process of the first forming rollers R10 is finished, the forming rotary die R11a surrounding the outside edge of the upper rotary die R11 is moved downward in a vertical direction, thus forming the sealing flange 103 of the housing 101.

When the operation of the forming rotary die R11a is finished, the second forming roller R10a further bends the secondarily bent top edge of the housing 101, which engages with the sealing flange 112 of the bottom plate 110, at an angle of 90° or more, thus forming the desired sealing flange 103 of the housing 101. This sealing flange 103 has a wedge groove 101a, and so the flange 103 almost completely prevents a leakage of oil from the junction of the filter housing 101 and the bottom plate 110 of the filter 100.

As described above, the embodiment of FIG. 6c is designed to hold the oil filter 100, consisting of the circular bottom plate 110 and the housing 101, by the upper and lower rotary dies R11 and R12. In this embodiment, the bottom plate 110 is closely fitted into the top edge of the filter housing 101, and is integrated with the top edge of the housing 101 into a single body through a laser welding process.

In such a case, the top edge of the housing 101 extends upright, and is integrated with the external surface of the vertically upwardly bent flange 112 of the bottom plate 110 at its internal surface through a laser welding process, which irradiates a laser beam to the external surface of the upright top edge of the housing 101.

The laser beam has straightness and indirectness, and is converged on a spot when it is focused using a lens, with highly intensive energy generated at the focus of the laser beam.

When such a laser beam is focused on a spot of a material, the material absorbs the laser energy at the spot, thus being partially and highly increased in its temperature and being fused at the spot. Therefore, the laser beam accomplishes a desired welding effect.

Such a laser welding process accomplishes a desired sealing effect even though a separate packing ring is not provided at the junction of the filter housing 101 and the bottom plate 110, thus preventing a leakage of oil from the junction during an operation of the oil filter.

In accordance with a drain back test, which is a conventional test for measuring the performance of oil filters, the oil filter 100 consisting of the housing 101 and the bottom plate 110 of the present invention did not allow a leakage of oil.

In the present invention, the bottom plate 100 may be changed in its shape in accordance with various embodiments. However, it should be understood that the bottom plate 100 is firmly assembled with the filter housing 101 while accomplishing a desired sealing effect at the junction of the housing 101 and the bottom plate 110 regardless of the different shapes of the bottom plate 110.

FIGS. 13a to 13c are sectional views, showing the process of forming the upper and lower adhesive parts 131 and 132 of a filtering element 130 included in the oil filter 100 of the present invention. As shown in the drawings, the metal part of each of the upper and lower adhesive parts 131 and 132 according to the present invention is preferably reduced in its size, with the remaining part of the adhesive parts 131 and 132 being formed by applying resin sealant, such as polyurethane, to the ends of the filtering paper 134, thus accomplishing a desired sealing effect at the adhesive parts 131 and 132. This also reduces the consumption of the material of the filtering element 130, and thereby reduces the production cost of the filtering element 130.

In order to form adhesive parts 131 and 132 on the filtering paper 134, a core 133 is inserted into the central bore of the filtering paper 134 as shown in FIG. 13a. In addition, liquid polyurethane having a desired viscosity is contained in a die P40 to reach a desired level. The filtering paper 134 is laid on the die P40 at its upper end so as to wet the end with the liquid polyurethane. The liquid polyurethane soaked through the upper end of the paper 134 is quickly hardened at a room temperature, thus forming an upper adhesive part 131 as shown in FIG. 13b.

The upper adhesive part 131 formed by the hardened polyurethane does not form any gap at the upper end of the filtering paper 134, thus accomplishing a desired oil sealing effect at the upper end of the paper 134. After the upper adhesive part 131 of the filtering paper 134 is completely formed, the lower end of the paper 134 is processed in the same manner as that described for the upper adhesive part 131, thus forming a lower adhesive part 132 as shown in FIG. 13c. The process of forming the lower adhesive part 132 of the filtering paper 134 remains the same as that described for the upper adhesive part 131, and further explanation is thus not deemed necessary.

In FIGS. 13a to 13c, only one die P40 is shown. However, it should be understood that the process of forming the adhesive parts 131 and 132 of the filtering paper 134 may be preferably performed with a plurality of dies P40, thus producing the filtering elements 130 in commercial quantities. In addition, it is possible to reduce the size of the upper and lower lids 131a and 132a of the filtering element 130, thus reducing the production cost of the filtering elements 130 of this invention.

FIGS. 14a to 14c are views, showing the process of forming the upper and lower adhesive parts 131 and 132 of a filtering element 130 in accordance with another embodiment of the present invention. As shown in the drawings, this embodiment is particularly designed to reduce the size of the upper and lower adhesive parts 131 and 132, made of polyurethane, and to optimally enlarge the filtering area of the filtering paper 134. The filtering element 130 according to this embodiment is produced without using the die P40 different from the embodiment of FIGS. 13a to 13c.

As described above, liquid polyurethane is applied to the upper and lower ends of the filtering paper 134 within a reduced area equal to the preferably reduced size of the upper and lower lids 131a and 132a, and is hardened at room temperature. Thereafter, the upper and lower ends of the paper 134 are covered by the lids 131a and 132a, thus producing a desired filtering element 130. This filtering element 130 is thus prevented from a leakage of oil through the junction of the filtering paper 134 and the two lids 131a and 132a.

As well known to those skilled in the art, polyurethane is capable of being hardened at room temperature, and is increased in its hardening rate in accordance with heat applied thereto. It is thus possible to retain a tight seal of the upper and lower adhesive parts 131 and 132 of the filtering paper 134, and to accomplish a desired sealing effect capable of preventing a leakage of oil.

FIG. 15 is a plan view of the filtering paper 134 used in the filtering element 130 of FIGS. 14a to 14c. As shown in the drawing, the filtering paper 134 of this invention is particularly designed to accomplish a desired sealing effect even though it is integrated with the small-size upper and lower lids 131a and 132a. In this filtering paper 134, the number of folded surfaces is larger than that of a conventional filtering paper 134, thus optimally increasing the filtering area of the paper 134.

That is, the desired filtering area of the filtering paper 134 may be changed in accordance with the engine using the filtering element 130. However, it is preferable to increase the filtering area of the paper 134 to a desired level of 0.5 m²-1.0 m² by optimally designing the upper and lower adhesive parts 131 and 132. In the present invention, the upper and lower adhesive parts 131 and 132 of the filtering paper 134 are limitedly formed at positions inside the edge of the paper 134, and so it is possible to preferably reduce the size of the paper 134 while enlarging the filtering area of the paper 134 in comparison with a conventional filtering paper.

FIG. 15 only shows the construction of the upper adhesive part 131 of the filtering paper 134 formed by an application of the liquid polyurethane. However, it should be understood that the lower adhesive part 132 has the same construction as that of the upper part 131, and further explanation is thus not deemed necessary.

As shown in FIG. 15, the polyurethane of the upper adhesive part 131 seals the gaps of the filtering paper 134 and the gaps between the paper 134 and the core 133. The upper and lower adhesive parts 131 and 132 of the filtering paper 134 almost completely prevent an undesired introduction of contaminated oil into the other parts except for the filtering paper 134, thus finally protecting the internal combustion engine using the oil filter 100 of this invention.

In addition, hot melt polyurethane is uniformly applied to the connection ends 134a of the filtering paper 134 as shown in FIG. 15, and so it is possible to retain a desired sealing effect without connecting the connection ends together using conventional paper clips. The process of producing the filtering element 130 is thus simplified since the filtering element 130 does not use such a conventional paper clip.

The polyurethane, used for forming the upper and lower adhesive parts 131 and 132 of the filtering element 130, will be described in detail herein below.

In the present invention, it is possible to directly use polyurethane produced by mixing isocyanates and polyol at a low temperature, or to use liquid polyurethane dissolved in a solvent free from dehydrated active hydrogen, such as hydrocarbon, or chloro-hydrocarbon, or to use thermoplastic polyurethane dissolved in a conventional solvent.

The polyurethane has a high elasticity, a high durability, a high abrasion resistance, a high oil resistance, and a high solvent resistance, and is quickly hardened.

The polyurethane used in the present invention has a high polarity at a lower viscosity, and so it is effectively reacted on the adhesive surface, and is effectively hardened at a room temperature, and is increased in its hardening rate in accordance with heat applied thereto.

FIG. 16 is a block diagram, showing the process of producing the oil filters 100 in accordance with the preferred embodiment of the present invention. As shown in the drawing, the manufacturing process of this invention is remarkably simplified in comparison with a conventional manufacturing process of producing oil filters using seaming caps, thus being finally improved in productivity.

That is, the process of producing the oil filters 100 according to the present invention is preferably free from a punching step, a piercing step, and an embossing step of making a seaming cap 120 in addition to a spot welding step of integrating the seaming cap 120 with a separately produced bottom plate 110.

In the process of producing the oil filters 100 according to this invention, the bottom plate 110 is made through a punching step PS of forming a disc-shaped plate body 111 from a metal plate, and a piercing step PI of forming an oil outlet hole 115 at the center of the punched plate body 111 and a plurality of oil inlet holes 114 on the plate body 111 at positions around the oil outlet hole 115.

After the plate body ill is completely formed through the punching step PS and the piercing step PI, a desired embossed pattern, including a packing seat 113 and a sealing flange 112, is formed on the plate body 111 through an embossing step EB using a press P10 of FIG. 5. In addition, a flange is formed along the edge of the oil outlet hole 115 of the plate body 111. The process of forming a desired bottom plate 110 is finished at the embossing step EB. Of course, the flanged oil outlet hole 115 of the plate body 111 has to be internally threaded through a tapping step, thus allowing the bottom plate 110 to be mounted to a filter head FH at the oil outlet hole 115 using a locking screw.

After the bottom plate 110 is completely formed as described above, a second packing ring 102b is laid in the packing seat 113 of the bottom plate 110. Thereafter, the bottom plate 110 is assembled with a filter housing 101 while accomplishing a desired sealing effect through a main assembling process 30. In such a case, the production of the filter housing 101 and an installation of a plurality of elements within the filter housing 101 are performed through a primary assembling process A1. The main assembling process 30 of assembling the bottom plate 110 and the filter housing 101 to form a resulting oil filter 100 is performed using a press P20, a flange-forming die P30, or a first forming roller R10 in accordance with a selected embodiment of this invention.

As well known to those skilled in the art, the process of producing a product in commercial quantities can be remarkably improved in productivity when one or more steps are removed from the process. In the present invention, the four steps, that is, the punching step, the piercing step, and the embossing step of making a seaming cap 120 in addition to the spot welding step of integrating the seaming cap 120 with the separately produced bottom plate 110 are removed from the oil filter manufacturing process. Therefore, it is possible for the present invention to remarkably simplify the oil filter manufacturing process, and to reduce the number of units from the oil filter production system, thus finally reducing the production cost and improving productivity while producing oil filters 100 having a desired operational performance.

In addition, the bottom plate 110 of the present invention does not have any sharpened edge, and so the bottom plate 110 is almost completely free from injuring worker's hands during the step of setting the packing rings on the bottom plate. The present invention thus prevents safety hazards to workers during the manufacturing process.

As described above, the present invention provides an oil filter for internal combustion engines, which is designed to be effectively and completely sealed by an easy and simple assemblage of a bottom plate with a filter housing, thus being free from a conventional seaming cap and being effectively produced using a reduced amount of material through a simplified production process requiring fewer man-hours, and thereby being reduced in its production cost. The oil filter according to the present invention also simplifies the construction of the filter production system, and is improved in productivity.

The oil filter for internal combustion engines and a method of manufacturing such filters according to the present invention effectively protects workers from safety hazards during the process of producing the filters.

In the oil filter of this invention and the method of manufacturing such filters, it is possible to almost completely prevent unexpected leakage of oil from a filtering element through the upper and lower adhesive parts, thus allowing the filtering element to perform its desired filtering function for an expected lengthy period of time and feeding desirably filtered oil to an engine, and thereby protecting the engine from any impurities of the oil.

In addition, the oil filter of this invention is designed to enlarge the effective filtering area of the filtering element, thus allowing the filtering element to accomplish a desired filtering effect using a small-size filtering paper.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. An oil filter, detachably assembled with a filter head of an internal combustion engine and used for filtering contaminated oil from said engine using its filtering element prior to feeding filtered oil to said engine, comprising:
a circular bottom plate assembled with said filter head, said bottom plate having:
one or more oil inlet holes formed on the bottom plate and used for introducing the contaminated oil from the engine into the oil filter;
an annular packing seat formed on the bottom plate at a position outside said oil inlet holes and used for seating a packing ring therein, thus allowing the packing ring to prevent a leakage of oil from the oil filter, with inside and outside annular dams formed along opposite edges of said packing seat and used for stably holding opposite sides of the packing ring, thus preventing the packing ring from being undesirably moved on the bottom plate due to inlet oil pressure;
an outside flange horizontally formed along an outside edge of said bottom plate; and
an oil outlet hole formed on the bottom plate at a central portion and mounted to said filter head by locking means, said oil outlet hole being also used for feeding filtered oil from a core of said filtering element to said engine; and
a filter housing tightly assembled with said bottom plate into a single body through a seaming process, in which a horizontally stepped top edge of said filter housing primarily engages with the horizontal outside flange with another packing ring being interposed between said horizontal outside flange of the bottom plate and the horizontal step of the filter housing, and is bent to tightly cover an upper surface of the outside flange of the bottom plate, thus forming a sealing flange preventing a leakage of contaminated oil from the oil filter through a seamed junction of the bottom plate and the filter housing.

2. The oil filter according to claim 1, wherein said outside flange of the bottom plate is bent upwardly, and the top edge of the filter housing is bent using a forming roller to tightly cover a top edge of the upwardly bent outside flange of said bottom plate, thus forming the sealing flange.

3. The oil filter according to claim 2, wherein the sealing flange formed by said bent top edge of the filter housing covering said upwardly bent outside flange of the bottom plate is further bent at an angle of 90° or more, thus improving oil sealing effect.

4. The oil filter according to claim 3, wherein an annular wedge groove is formed on an external surface of said top edge of the filter housing, thus preventing a leakage of contaminated oil from the seamed junction of the filter housing and the bottom plate due to an excessive pressure within the oil filter.

5. The oil filter according to claim 1, wherein said bottom plate is bent upwardly along its outside flange, and is closely fitted into the top edge of the filter housing prior to being integrated together into a single body through a laser welding process.

6. The oil filter according to claim 1, wherein a hot melt sealant is applied to opposite ends of a filtering paper of said filtering element, thus forming lid adhesive parts having the same size as that of small-size upper and lower lids and optimally increasing a filtering area of the filtering paper.

7. A method of manufacturing an oil filter, comprising:
a primary assembling step of vertically setting a support spring within a drawn filter housing of a predetermined depth at a predetermined position, and setting a relief valve and a cored filtering element within said filtering housing at positions above the support spring, thus allowing the relief valve and the filtering element to be supported by the support spring;
a bottom plate forming step of punching a metal sheet to form a disc-shaped plate body, piercing said plate body to form both an oil inlet hole and a central hole, primarily forming an oil outlet hole at the central hole of the plate body by a first forming die descending above a support die stably inserted into said central hole of the plate body, and forming a specifically embossed pattern on the bottom plate by both an embossed lower surface of a descending second forming die and an embossed upper surface of a fixed die; and
a main assembling step of laying the filter housing in a central bore of a lower die by seating a horizontal step of the filter housing on a top edge of said bore, seating the bottom plate on the horizontal step of the filter housing with both a first packing ring laid between an outside flange of the bottom plate and the horizontal step of the filter housing and a second packing ring laid on the bottom plate at a predetermined position, compressing the bottom plate using a compression die to accomplish a sealing effect of the second packing ring and to set a position of the bottom plate on the filter housing, descending a first compression die surrounding said compression die, and bending a top edge of the filter housing by moving a flange-forming die to allow said top edge to cover the outside flange of the bottom plate, thus forming a sealing flange.

8. The method according to claim 7, wherein said flange-forming die comprises four arc-shaped pieces individually having an inclined part at its outside surface, said inclined part of the arc-shaped pieces of the flange-forming die coming into contact with an inclined part formed on an inside surface of said first compression die, thus moving forward to bend the top edge of said filter housing at an angle of 90° so as to form the sealing flange.

9. The method according to claim 7, wherein a support block is laid on a bottom surface of the central bore of said lower die, and is used for supporting the filter housing within said bore, thus allowing the top edge of said filter housing to be bent when said top edge is free from the horizontal step.

10. The method according to claim 7, wherein said top edge of said filter housing is primarily bent by a rotatable first forming roller, and is secondarily bent by a descending rotatable forming die, thus being bent inwardly.

11. The method according to claim 10, wherein said top edge of the filter housing is bent at an angle of 90° or more by a second forming roller.

12. The method according to claim 7, wherein the top edge of the filter housing extends upright, and is integrated with an external surface of a vertically, upwardly bent outside flange of said bottom plate at its internal surface through a laser welding process irradiating a laser beam to an external surface of said upright top edge of the filter housing.
